(19) United States
(12) Patent Application Publication
(10) Pub. No.: US 2023/0162335 A1
(43) Pub. Date: May 25, 2023

(54) IMAGE ADJUSTMENT APPARATUS, IMAGE ADJUSTMENT METHOD AND PROGRAM

(71) Applicant: NIPPON TELEGRAPH AND TELEPHONE CORPORATION, Tokyo (JP)

(72) Inventors: Xiaomeng WU, Musashino-shi, Tokyo (JP); Takahito KAWANISHI, Musashino-shi, Tokyo (JP); Kunio KASHINO, Musashino-shi, Tokyo (JP)

(73) Assignee: NIPPON TELEGRAPH AND TELEPHONE CORPORATION, Tokyo (JP)

(21) Appl. No.: 17/921,103

(22) PCT Filed: Apr. 27, 2020
(86) PCT No.: PCT/JP2020/017942

§ 371 Date: Oct. 24, 2022

(51) Int. Cl. G06T 5/00

(52) U.S. Cl. CPC G06T 5/009; G06T 5/002

(57) ABSTRACT

An image adjustment apparatus includes an input unit configured to acquire a grayscale image, the grayscale image being an image representing a contrasting density using a contrast of luminance, and a luminance transform unit configured to transform luminances of pixels of the grayscale image using a luminance transform function with a function value varying depending on coordinates in the grayscale image on the basis of a camera response function to generate a transformed grayscale image and output the transformed grayscale image to a predetermined device, the transformed grayscale image being the grayscale image with a global brightness being adaptively adjusted and with the luminance being transformed in such a manner that local details are enhanced.

### TECHNICAL FIELD

The present invention relates to an image adjustment apparatus, an image adjustment method, and a program.

### BACKGROUND ART

In recent years, the demand for image enhancement processing has increased significantly. For example, in order to reveal details hidden in an image with a narrow dynamic range, processing to enhance contrast may be performed on the image. However, a user is required to have expertise in image editing for the user to obtain sufficient enhancement results using commercially available image editing software. Many manual operations may also be required of the user. As such, there is a need for an adaptive image enhancement method (image adjustment method) that automatically corresponds to various input images.

Histogram equalization that is one method of image enhancement is the most focused method because it has intuitive implementation quality and high efficiency. In the histogram equalization, a function to transform a luminance of an input image (hereinafter, referred to as the “luminance transform function”) is derived so that an entropy of luminance distribution in the image is maximized. Hereinafter, an image representing a contrasting density using a contrast (difference) between pixel values (luminances) of pixels is referred to as a “grayscale image”.

In a method described in NPL 1, a gradient of a reflectance component image of a grayscale image is derived as a local contrast value. A luminance histogram weighted with contrast values is also derived. In the method described in NPL 1, the adaptive image enhancement corresponding to the various input images is achieved by the luminance histogram equalization, without brightness of the input images being excessively enhanced.

However, in the method described in NPL 1 and the histogram equalization, the monotonic constraints are imposed on the luminance transform function. That is, in the method described in NPL 1 and the histogram equalization, the constraint that a luminance of an output image transformed using the luminance transform function must always be increased in accordance with an increase in a luminance of the input image is imposed on the luminance transform function.

In the Retinex theory, an image in which a natural scene is captured is considered as a combination of an illumination component image and a reflectance component image. The illumination component image constitutes a global contrast and the reflectance component image constitutes a local detail.

In a method described in NPL 2, the reflectance component image is considered as a desired output image in which a contrast is enhanced. An estimated illumination component image is removed from the input image to derive an output image in which the contrast is enhanced relative to the input image. In the method described in NPL 2, parameters are appropriately adjusted to effectively enhance dark local details in the image. However, the global contrast in the image is completely lost, and thus, a global brightness in the image is disadvantageously excessive.

A method of enhancing an illumination component in an illumination component image has been proposed for the purpose of brightening an image without loss of a global contrast in the image. In this method, an input image is decomposed into an illumination component image and a reflectance component image. An illumination component in the illumination component image is moderately enhanced, and the enhanced illumination component image and the reflectance component image are recombined.

For example, in the method described in NPL 3, the illumination component in the estimated illumination component image is enhanced with gamma correction, and the illumination component image including the enhanced illumination component and the reflectance component image are recombined. The recombined image is output as an image of which brightness is enhanced. However, the gamma correction cannot adaptively brighten the image. Therefore, the brightness of the image may be excessive in the method disclosed in NPL 3. The brightness of the image may be insufficient.

### CITATION LIST

### Non Patent Literature

NPL 1: Xiaomeng Wu, Takahito Kawanishi, and Kunio Kashino, “REFLECTANCE-GUIDED, CONTRAST-ACCUMULATED HISTOGRAM EQUALIZATION,” IEEE International Conference on Acoustics, Speech, and Signal Processing (ICASSP) 2020.
NPL 2: Xiaojie Guo, Yu Li, and Haibin Ling, “LIME: Low-light image enhancement via illumination map estimation,” IEEE Transactions On Image Processing, Vol. 26, No. 2, pp. 982-993, 2017.
NPL 3: Xueyang Fu, Delu Zeng, Yue Huang, Xiao-Ping Zhang, and Xinghao Ding, “A weighted variational model for simultaneous reflectance and illumination estimation,” In Computer Vision and Pattern Recognition (CVPR), pp. 2782-2790, 2016.

### SUMMARY OF THE INVENTION

### Technical Problem

In the method described in NPL 1, as long as a region where a contrast of a luminance (pixel value) is enhanced is present in the image, contrasts of luminances in other regions in the image are necessarily suppressed due to the monotonic constraints. As a result of the contrast being suppressed, there is a problem in the method described in NPL 1 that the local details in the image are attenuated. The same applies to the histogram equalization. In this way, the local details may not be enhanced in the image of which the global brightness is adaptively adjusted.

In light of the foregoing, the present invention has an object to provide an image adjustment apparatus, an image adjustment method, and a program capable of enhancing local details in an image of which global brightness is adaptively adjusted.

### Means for Solving the Problem

An aspect of the present invention is an image adjustment apparatus including: an input unit configured to acquire a grayscale image, the grayscale image being an image representing a contrasting density using a contrast of luminance; and a luminance transform unit configured to transform luminances of pixels of the grayscale image using a luminance transform function with a function value varying depending on coordinates in the grayscale image on the basis of a camera response function to generate a transformed grayscale image and output the transformed grayscale image to a predetermined device, the transformed grayscale image being the grayscale image with a global brightness being adaptively adjusted and with the luminance being transformed in such a manner that local details are enhanced.

An aspect of the present invention is an image adjustment method performed by an image adjustment apparatus. The image adjustment method includes: acquiring a grayscale image, the grayscale image being an image representing a contrasting density using a contrast of luminance; and transform luminances of pixels of the grayscale image using a luminance transform function with a function value varying depending on coordinates in the grayscale image on the basis of a camera response function to generate a transformed grayscale image and output the transformed grayscale image to a predetermined device, the transformed grayscale image being the grayscale image with a global brightness being adaptively adjusted and with the luminance being transformed in such a manner that local details are enhanced.

An aspect of the present invention is a program for causing a computer to function as the image adjustment apparatus described above.

### Effects of the Invention

According to the present invention, the local details can be enhanced in the image with the global brightness being adaptively adjusted.

### BRIEF DESCRIPTION OF DRAWINGS

FIG. 1 is a diagram illustrating a configuration example of an image adjustment apparatus according to an embodiment.

FIG. 2 is a diagram illustrating an example of a hardware configuration of the image adjustment apparatus according to the embodiment.

FIG. 3 is a flowchart illustrating an operation example of a luminance transform unit of the image adjustment apparatus according to the embodiment.

FIG. 4 is a diagram illustrating a first example of a comparison between a transformed grayscale image and other images according to the embodiment.

FIG. 5 is a diagram illustrating a second example of the comparison between a transformed grayscale image and other images according to the embodiment.

FIG. 6 is a diagram illustrating a third example of the comparison between a transformed grayscale image and other images according to the embodiment.

FIG. 7 is a diagram illustrating a fourth example of the comparison between a transformed grayscale image and other images according to the embodiment.

FIG. 8 is a diagram illustrating a fifth example of the comparison between a transformed grayscale image and other images according to the embodiment.

FIG. 9 is a diagram illustrating a sixth example of the comparison between a transformed grayscale image and other images according to the embodiment.

FIG. 10 is a diagram illustrating a seventh example of the comparison between a transformed grayscale image and other images according to the embodiment.

FIG. 11 is a diagram illustrating an eighth example of the comparison between a transformed grayscale image and other images according to the embodiment.

### DESCRIPTION OF EMBODIMENTS

In the following, a computation of a matrix is performed per element of an image. In the following, all pixel values in the image are normalized within a range [0, 1].

In the following, a method of post-processing for any image enhancement method (hereinafter, referred to as a “base image enhancement method”) is proposed. Hereinafter, a grayscale image with a luminance being adjusted using the base image enhancement method is referred to as an “enhanced grayscale image”. In the following, transformation from a grayscale image “Aᵢₙ” to an enhanced grayscale image is approximated by a non-monotonic luminance transform function. That is, the transformation from the grayscale image “Aᵢₙ” to the enhanced grayscale image is approximated by the luminance transform function that varies in response to coordinates in the image (the spatially varying luminance transform function). A method for enhancing a grayscale image using such an approximated non-monotonic luminance transform function is also proposed.

In the following, the base image enhancement method is, for example, a method capable of adaptively enhancing a global brightness of an image. In a case that a method in which a grayscale image is enhanced using a monotonic luminance transform function is employed as an example of the base image enhancement method, the post-processing for the base image enhancement method is significantly effective. As such, in the following, the method in NPL 1 is used as an example of the base image enhancement method.

In a case that the non-monotonic luminance transform function is used to enhance a contrast in an image, the non-monotonic luminance transform function needs to be able to enhance local details in the image. Thus, the non-monotonic luminance transform function needs to be a spatially varying function, i.e., a function with a function value varying depending on coordinates in the image. To meet these requirements, in the following, a non-monotonic luminance transform function is derived on the basis of a camera response function.

In a reference literature 1 “Steve Mann, “Comparametric equations with practical applications in quantigraphic image processing,” IEEE Trans. Image Processing, Vol. 9, No. 8, pp. 1389-1406, 2000.”, proposed is a method of deriving a luminance transform function from a camera response function by solving a comparametric equation. In the luminance transform function, parameters for the camera response function (CRF) (hereinafter, referred to as the “CRF parameters”) and an exposure value of a picture are used as variables. Here, the exposure value is a scalar.

Hereinafter, a luminance of an output image transformed from a luminance of an input image is referred to as a “transformed luminance.” The transformed luminance is obtained by transforming the luminance of the input image by using the luminance transform function derived from the camera response function. The larger the exposure value, the higher the transformed luminance. That is, the smaller the exposure value, the lower the transformed luminance. As long as the exposure value is a scalar, the luminance transform function derived from the camera response function for transforming the luminance of the input image to the transformed luminance is a monotonically increasing function. Thus, the luminance transform function derived from the camera response function for transforming the luminance of the input image to the transformed luminance, without change, is not usable as a non-monotonic luminance transform function.

In a case that a region around a pixel is originally dark, a transformed luminance of the pixel needs to be increased to improve visibility of a local detail of an image. In a case that a region around a pixel is originally bright, a transformed luminance of the pixel needs to be decreased to improve visibility of a local detail of an image.

As described above, the larger the exposure value, the higher the transformed luminance, and the smaller the exposure value, the lower the transformed luminance. That is, in the case that the region around the pixel is originally dark, the exposure value needs to be increased to improve the visibility of the local detail of the image. In the case that the region around the pixel is originally bright, the exposure value needs to be decreased to improve visibility of the local detail of the image.

The following focuses on a smoothed grayscale image. Hereinafter, the smoothed grayscale image is referred to as a “smooth grayscale image”. In the case that the region around the pixel is originally dark, pixel values of the smooth grayscale image are small. In the case that the region around the pixel is originally bright, the pixel values of the smooth grayscale image are large. As such, in the following, a method in which a positive real matrix inversely proportional to the pixel values of the smooth grayscale image is used as an exposure value matrix is proposed.

The luminance transform function of this exposure value matrix as a variable is a function that does not monotonically increase. The transformed luminance is defined depending on the luminance of the input image and the original brightness (darkness) in the region around the pixel. The use of the luminance transform function of the exposure value matrix as a variable allows the local details of the image to be enhanced.

Thus, in the following, transformation from a grayscale image to an enhanced grayscale image is approximated by the luminance transform function of the exposure value matrix described above as a variable. To achieve an object to approximate in this way, the image adjustment apparatus makes the luminance transform function fit to image data that includes the grayscale image and the enhanced grayscale image. This derives the CRF parameter as a variable of the luminance transform function. The luminance transform function of the derived CRF parameter as a variable is applied to the grayscale image. The luminance of the grayscale image is transformed using the luminance transform function of the CRF parameter as a variable to enhance the grayscale image. Hereinafter, the grayscale image with the luminance being transformed using the luminance transform function of the CRF parameter as a variable is referred to as a “transformed grayscale image”.

In this way, the image adjustment apparatus derives the enhanced grayscale image using the base image enhancement method. The image adjustment apparatus then uses, as the camera response function, a monotonically increasing function with one or more parameters (CRF parameters). The image adjustment apparatus solves a comparametric equation of the function to derive the luminance transform function. The image adjustment apparatus then derives a smooth grayscale image from the grayscale image. Here, the image adjustment apparatus derives a positive real matrix inversely proportional to the pixel values of the smooth grayscale image as an exposure value matrix of the luminance transform function. Next, the image adjustment apparatus calculates the CRF parameter for the luminance transform function so that a difference between the enhanced grayscale image and the transformed grayscale image (e.g., a residual sum of squares) satisfies a predetermined condition. This predetermined condition is a condition that, for example, the difference between the enhanced grayscale image and the transformed grayscale image is minimized. The image adjustment apparatus applies the luminance transform function to the grayscale image to transform the luminance of the grayscale image. This generates a transformed grayscale image.

An embodiment of the present invention will be described in detail with reference to the drawings.

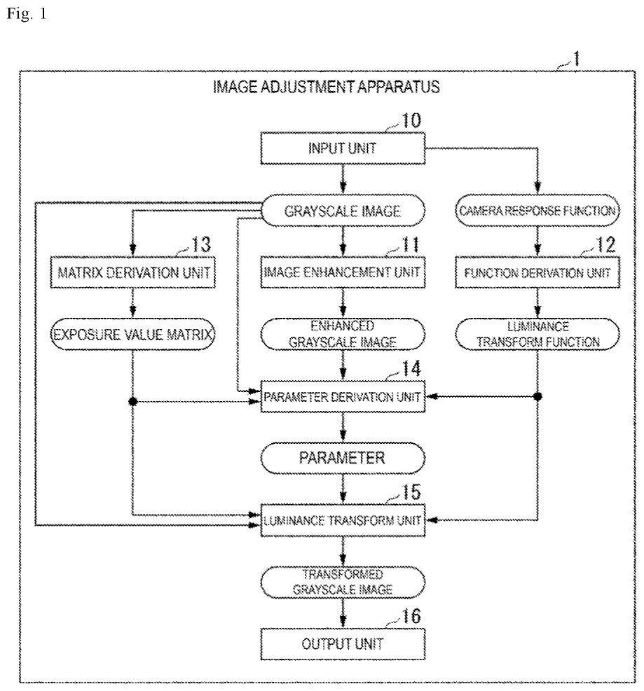

FIG. 1 is a diagram illustrating a configuration example of an image adjustment apparatus 1. The image adjustment apparatus 1 is an apparatus for adjusting an image. For example, the image adjustment apparatus 1 is an apparatus for adjusting contrast of the luminance. The image adjustment apparatus 1 adaptively adjusts a global brightness (luminance) in an input image using any image enhancement method. The image adjustment apparatus 1 enhances local details in the input image with the global brightness being adjusted in post-processing.

The image adjustment apparatus 1 includes an input unit 10, an image enhancement unit 11, a function derivation unit 12, a matrix derivation unit 13, a parameter derivation unit 14, a luminance transform unit 15, and an output unit 16.

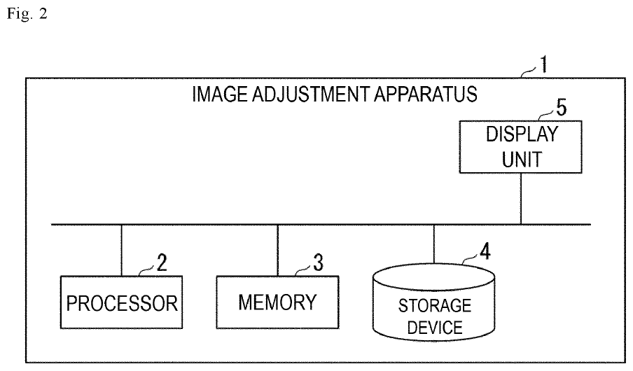

FIG. 2 is a diagram illustrating an example of a hardware configuration of the image adjustment apparatus 1. The image adjustment apparatus 1 includes a processor 2, a memory 3, a storage device 4, and a display unit 5.

Some or all of the functional units of the image adjustment apparatus 1 are realized as software by the processor 2 such as a central processing unit (CPU) executing a program loaded in the memory 3 from the storage device 4 which is a nonvolatile recording medium (non-transitory recording medium). The program may be recorded on a computer-readable recording medium. The computer-readable recording medium is a portable medium such as a flexible disk, a magneto-optical disc, a read only memory (ROM), or a compact disc read only memory (CD-ROM) or a non-temporary recording medium such as a storage device such as a hard disk provided in a computer system, for example. The program may be received via an electrical communication line. The display unit 5 is a device capable of displaying an image. The display unit 5 is, for example, a liquid crystal display.

Some or all of the functional units of the image adjustment apparatus 1 may be realized by using hardware including an electronic circuit (or circuitry) using a large scale integration circuit (LSI), an application specific integrated circuit (ASIC), a programmable logic device (PLD), or a field programmable gate array (FPGA), for example.

Returning to FIG. 1, an overview of the image adjustment apparatus 1 will be described.

The input unit 10 acquires a grayscale image as an input image. In the grayscale image, pixels having different pixel values (brightness or luminance) are used to represent the contrasting density. The input unit 10 derives a camera response function by use of the grayscale image. The input unit 10 outputs a grayscale image to the image enhancement unit 11, the matrix derivation unit 13, the parameter derivation unit 14, and the luminance transform unit 15. The input unit 10 outputs the camera response function to the function derivation unit 12.

The image enhancement unit 11 acquires the grayscale image as the input image from the input unit 10.

The image enhancement unit 11 applies the base image enhancement method to the grayscale image to derive an enhanced grayscale image. The image enhancement unit 11 outputs the enhanced grayscale image to the parameter derivation unit 14.

Any method of adjusting the luminance may be used as the base image enhancement method. The base image enhancement may be preferably, for example, a method capable of adaptively enhancing a global brightness of an image. In a case that a method of enhancing a grayscale image using a monotonic luminance transform function is employed as the base image enhancement method, the method according to the present embodiment is significantly effective. The method of enhancing a grayscale image using a monotonic luminance transform function may be, for example, any of histogram equalization, gamma correction, the method described in a reference literature 2, “Xiaomeng Wu, Xinhao Liu, Kaoru Hiramatsu, and Kunio Kashino, “Contrast-accumulated histogram equalization for image enhancement,” In ICIP, pp. 3190-3194, 2017.”, and the method described in NPL 1.

In the following, the method described in NPL 1 is employed as the base image enhancement method. The image enhancement unit 11 derives a gradient of a reflectance component image of the grayscale image as a local contrast value of the grayscale image. Here, the image enhancement unit 11 derives a luminance histogram of the grayscale image weighted with contrast values. The image enhancement unit 11 equalizes the luminance histogram to transform the luminance of the grayscale image. The image enhancement unit 11 derives the grayscale image with the luminance being transformed in this way as the enhanced grayscale image.

The function derivation unit 12 acquires the camera response function as an input from the input unit 10. The function derivation unit 12 uses as the camera response function a monotonically increasing function with one or more parameters (CRF parameters) to solve a comparametric equation of the monotonically increasing function. The function derivation unit 12 solves the comparametric equation of the monotonically increasing function to derive a luminance transform function. The luminance transform function, without change, is not usable as a non-monotonic luminance transform function. The function derivation unit 12 outputs the derived luminance transform function to the parameter derivation unit 14 and the luminance transform unit 15.

Any monotonically increasing function with one or more parameters can be used as the camera response function “f(⋅)”. Here, a function satisfying “f(0)=0” and “f(1)=1” is preferably used as the camera response function “f(⋅)”.

An unknown real matrix “Q” having the same size as the grayscale image is used as a variable of the camera response function. The real matrix “Q” represents an irradiance of each pixel when a grayscale image is captured. The function value “f(Q)” of the camera response function represents an image captured by the camera, or a grayscale image.

A comparametric equation of the camera response function is expressed in a form of an equation (1).

[Math. 1]

g(ƒ(Q))=ƒ(EQ) (1)

Here, “g(⋅)” is a comparametric function of “f(⋅)”. According to the reference literature 1 described above, the comparametric function “g(⋅)” can be used as a luminance transform function applied to a grayscale image.

The variable “E” in the equation (1) represents an exposure value. The exposure value “E” is typically a scalar. The exposure value “E” is defined depending on a combination of a diaphragm amount of a camera lens, an exposure time when a grayscale image is captured, a film sensitivity, and the like. However, in a case that camera information such as camera parameters is unknown, the exposure value “E” is unknown. In a case that the comparametric function “g(⋅)” is used as a luminance transform function, the exposure value “E” needs to be preset as a parameter. The exposure value “E” is derived by the matrix derivation unit 13.

The function derivation unit 12 solves the equation (1) that is the comparametric equation of the camera response function “f(⋅)” to derive, as a luminance transform function, the comparametric function “g(⋅)” of the camera response function. The function value “f(Q)” of the camera response function corresponds to a grayscale image “Aᵢₙ”. In other words, “f(Q)=Aᵢₙ” is satisfied. Then, the equation (1) is expressed as an equation (2).

[Math. 2]

g(Aᵢₙ)=ƒ(Eƒ⁻¹(Aᵢₙ)) (2)

Thus, in a case that the camera response function “f(⋅)” is invertible, the comparametric function “g(⋅)” that is usable as a luminance transform function is derivable from the equation (2).

Note that the more the number of CRF parameters for the camera response function, the higher a fitting capability of the luminance transform function derived by the function derivation unit 12. However, in a case that the number of CRF parameters is too large, the processing time will be very long and the possibility of overfitting occurring in the parameter derivation unit 14 is also high. This overfitting is that the transformation from the grayscale image to the enhanced grayscale image (the base image enhancement method) is excessively approximated by the luminance transform function derived by the function derivation unit 12. This occurs because the degree of freedom of the luminance transform function derived by the function derivation unit 12 is too high. As a result of the overfitting occurring, there is a possibility that the transformed grayscale image (the grayscale image with the luminance being transformed using the luminance transform function) and the enhanced grayscale image may become identical images. In the case that the transformed grayscale image and the enhanced grayscale image become identical images, the local details of the image cannot be recovered. As long as the pixel value with the contrast being enhanced using the base image enhancement method exists, the problem that contrasts of other pixel values are necessarily suppressed cannot be resolved in the case that the local details of the image cannot be recovered. Therefore, in order to avoid the overfitting and obtain a more balanced image adjustment performance, it is more appropriate to use a function with two CRF parameters.

A first example of the luminance transform function derived by the function derivation unit 12 is derived as expressed by an equation (3) to an equation (5). In a derivation process in the first example of the luminance transform function derived by the function derivation unit 12, a sigmoidal function is used as the camera response function. The sigmoidal function is expressed as the equation (3).

$$\begin{matrix}[ Math . 3 ] & \\ f ( Q ) = \frac{( 1 + α ) {Q}^{β}}{{Q}^{β} + α} & ( 3 )\end{matrix}$$

Here, “α” represents a first CRF parameter for the sigmoidal function. “β” represents a second CRF parameter for the sigmoidal function. An inverse function of the equation (3) is expressed as the equation (4).

$$\begin{matrix}[ Math . 4 ] & \\ {f}^{- 1} ( {A}_{in} ) = {( \frac{α {A}_{in}}{1 + α - {A}_{in}} )}^{1 / β} & ( 4 )\end{matrix}$$

The function derivation unit 12 substitutes the equation (3) and the equation (4) into the equation (2) to derive the comparametric function “g(⋅)” that is usable as a luminance transform function. The first example of the luminance transform function is expressed as the equation (5).

$$\begin{matrix}[ Math . 5 ] & \\ g ( {A}_{in} ) = \frac{( 1 + α ) {E}^{β} {A}_{in}}{( {E}^{β} - 1 ) {A}_{in} + 1 + α} & ( 5 )\end{matrix}$$

On the other hand, a second example of the luminance transform function derived by the function derivation unit 12 is derived as expressed by an equation (6) to an equation (8). In a derivation process in the second example of the luminance transform function derived by the function derivation unit 12, a power function is used as the camera response function. The power function is expressed as the equation (6).

[Math. 6]

ƒ(Q)=Q^{γ} (6)

Here, “γ” represents one CRF parameter. An inverse function of the equation (6) is expressed as the equation (7).

[Math. 7]

ƒ⁻¹(Aᵢₙ)=Aᵢₙ^{1/γ} (7)

The function derivation unit 12 substitutes the equation (6) and the equation (7) into the equation (2) to derive the comparametric function “g(⋅)” that is usable as a luminance transform function. The second example of the luminance transform function derived by the function derivation unit 12 is expressed as an equation (8).

[Math. 8]

g(Aᵢₙ)=E^{γ}Aᵢₙ (8)

The description of the first example of the luminance transform function and the second example of the luminance transform function is described above.

The matrix derivation unit 13 acquires the grayscale image as the input image from the input unit 10. The matrix derivation unit 13 derives the smoothed grayscale image as a smooth grayscale image. The matrix derivation unit 13 derives a positive real matrix inversely proportional to the pixel values of the smooth grayscale image as an exposure value matrix. The matrix derivation unit 13 outputs the exposure value matrix to the parameter derivation unit 14 and the luminance transform unit 15.

An object of the present embodiment is to recover or enhance the local details of the image attenuated due to enhancing the image using the base image enhancement method. To achieve this object, the luminance transform unit 15 applies the luminance transform function derived from the function derivation unit 12 to the grayscale image to transform the luminance of the grayscale image. Thus, the luminance transform function needs to be a function capable of enhancing the local details of the image. Therefore, the luminance transform function used by the luminance transform unit 15 needs to be a non-monotonic function that spatially varies within the image and has a different value depending on the coordinates (position) of each pixel in the image. Hereinafter, a requirement that the variation in the function value is not monotonic is referred to as a “non-monotonic requirement”. A requirement that the function value spatially varies within the image and has a different value (has a value varying) depending on the coordinates (position) of each pixel in the image is referred to as a “spatial variability requirement”.

As expressed by the equation (5) and the equation (8), in the case that the exposure value is a scalar, the luminance transform function derived by the function derivation unit 12 monotonically increases. That is, in the case that the exposure value is a scalar, the luminance transform function derived by the function derivation unit 12 does not meet the non-monotonic requirement nor spatial variability requirement described above. As expressed by the equation (5) and the equation (8), the larger the exposure value, the higher the transformed luminance “g(Aᵢₙ)”, and the smaller the exposure value, the lower the transformed luminance “g(Aᵢₙ)”.

On the other hand, in order to improve visibility of the local details of the image, in the case that a region around a pixel is originally dark, the image adjustment apparatus 1 needs to increase a transformed luminance of the pixel. In the case that a region around a pixel is originally bright, the image adjustment apparatus 1 needs to decrease a transformed luminance of the pixel. In this manner, two viewpoints are considered: of improving the visibility of the local details and of the case that the region around the pixel is originally bright.

By combining these viewpoints, it is found that it is necessary to increase the exposure value in the case that the region around the pixel is originally dark and decrease the exposure value in the case that the region around the pixel is originally bright in order to improve the visibility of the local details in the image. Hereinafter, such a requirement for the exposure value is referred to as an “exposure value requirement”.

For studying how to derive the exposure value meeting the exposure value requirement, the smoothed grayscale image can be focused on. Hereinafter, the smoothed grayscale image is referred to as the “smooth grayscale image”. In the case that the region around the pixel is originally dark, the pixel value of the smooth grayscale image is small. In the case that the region around the pixel is originally bright, the pixel value of the smooth grayscale image is large. That is, a positive real matrix inversely proportional to the pixel values of the smooth grayscale image necessarily satisfies the exposure value requirement described above. In the following, a method in which the positive real matrix inversely proportional to the pixel values of the smooth grayscale image is used as an exposure value matrix is proposed.

The smooth grayscale image is derivable using any method capable of smoothing the grayscale image. However, to derive a more desirable smooth grayscale image, it is more appropriate to use a method called edge preserving smoothing. In a case that a method other than the edge preserving smoothing is used, a halo effect may be generated in the transformed grayscale image (the grayscale image with the luminance being transformed using the luminance transform function). That is, an uncomfortable defect may occur near an edge where the brightness sharply changes (such as a boundary of a subject).

Examples of the edge preserving smoothing methods include a median filter, a bilateral filter, a guided filter, an anisotropic diffusion filter, and a method described in a reference literature 3 “Li Xu, Qiong Yan, Yang Xia, and Jiaya Jia, “Structure extraction from texture via relative total variation. ACM Trans. Graph,” Vol. 31, No. 6, pp. 139:1-139:10, 2012.”

The matrix derivation unit 13 derives a smooth grayscale image using the method described in the reference literature 3, as an example. In the method described in the reference literature 3, a ratio of an average of absolute values of a first derivative of luminance in a local region around the pixel to an absolute value of an average of the first derivative of luminance is measured for each pixel as the texture intensity. The smooth grayscale image is optimized such that a sum of the difference between the grayscale image and the smooth grayscale image, and the texture intensity is as small as possible. The matrix derivation unit 13 derives an image resulting from the optimization as the smooth grayscale image.

The matrix derivation unit 13 derives a positive real matrix inversely proportional to the pixel values of a smooth grayscale image “I” as the exposure value matrix of the luminance transform function. The matrix derivation unit 13 derives the exposure value matrix “E” such as “E=1/I”.

Note that the matrix derivation unit 13 can use any positive real matrix inversely proportional to the smooth grayscale image. In a case that it can be assumed that the pixel values of the smooth grayscale image “I” are normalized within a range [0, 1], the matrix derivation unit 13 may derive the exposure value matrix “E” such as “E=1−I”.

The exposure value matrix thus obtained satisfies the exposure value requirement described above. As a result, the luminance transform function of the exposure value matrix as a variable meets the non-monotonic requirement and spatial variability requirement described above. Accordingly, the luminance transform unit 15 can use the luminance transform function of the exposure value matrix as a variable to enhance the local details of the image.

The parameter derivation unit 14 acquires the grayscale image from the input unit 10, the grayscale image being an input. The parameter derivation unit 14 acquires the enhanced grayscale image from the image enhancement unit 11, the enhanced grayscale image being an input. The parameter derivation unit 14 acquires the luminance transform function from the function derivation unit 12, the luminance transform function being an input. The parameter derivation unit 14 acquires the exposure value matrix from the matrix derivation unit 13, the exposure value matrix being an input.

The parameter derivation unit 14 derives the CRF parameters for the luminance transform function so that a difference between the enhanced grayscale image and the transformed grayscale image (e.g., a residual sum of squares) satisfies a predetermined condition (for example, is minimized). The parameter derivation unit 14 outputs the CRF parameters for the luminance transform function to the luminance transform unit 15.

In the related art, the CRF parameters are set by a professional on the basis of the camera response function, or are derived by a machine learning scheme by used of a data set of the camera response function. In either case, the CRF parameter of the related art has a fixed value. Accordingly, the CRF parameter of the related art is not adaptively set in response to a situation of the grayscale image acquired as the input image.

In a case that the CRF parameter is used as an argument of the luminance transform function, the CRF parameter primarily serves to control the global brightness of the transformed grayscale image. In the present embodiment, the enhanced grayscale image is used as an image having an optimal global brightness to derive the CRF parameters such that the transformed grayscale image is as close as possible to the enhanced grayscale image. This allows the parameter derivation unit 14 to adaptively derive the CRF parameters in response to the situation of the grayscale image.

The parameter derivation unit 14 derives the CRF parameters for the luminance transform function so as to minimize a residual sum of squares between the enhanced grayscale image and the transformed grayscale image. The CRF parameter is expressed as an equation (9). Here, “θ” represents a set of CRF parameters. “B” represents an enhanced grayscale image. “g(Aᵢₙ; θ)” represents the transformed luminance “g(Aᵢₙ)”.

$$\begin{matrix}[ Math . 9 ] & \\ Θ = {argmin}_{Θ} {‖ B - g ( {A}_{in} ; Θ ) ‖}^{2} & ( 9 )\end{matrix}$$

In a case that a sigmoidal function expressed as the equation (3) is used as the camera response function, the CRF parameters are expressed as an equation (10). Here, “E” represents an exposure value matrix.

$$\begin{matrix}[ Math . 10 ] & \\ \{ α , β \} = {argmin}_{\{ α , β \}} {‖ B - \frac{( 1 + α ) {E}^{β} {A}_{in}}{( {E}^{β} - 1 ) {A}_{in} + 1 + α} ‖}^{2} & ( 10 )\end{matrix}$$

In a case that a “power function” expressed as the equation (6) is used as the camera response function, the CRF parameter is expressed as an equation (11).

$$\begin{matrix}[ Math . 11 ] & \\ \{ γ \} = {argmin}_{\{ γ \}} {‖ B - {E}^{γ} {A}_{in} ‖}^{2} & ( 11 )\end{matrix}$$

The problem of deriving the CRF parameters expressed as the equation (9), (10), or (11) can be considered as a nonlinear programming problem or a nonlinear regression problem. Accordingly, the parameter derivation unit 14 can derive the CRF parameters by solving the equation (9), (10), or (11) using any method capable of solving the nonlinear programming problem or the nonlinear regression problem. Examples of the method capable of solving the nonlinear programming program or the nonlinear regression problem include the Nelder-Mead method (a reference literature 4 “Jeffrey C. Lagarias, James A. Reeds, Margaret H. Wright, and Paul E. Wright, “Convergence properties of the Nelder-Mead simplex method in low dimensions,” SIAM Journal on Optimization, Vol. 9, No. 1, pp. 112-147, 1998.”), the Levenberg-Marquardt method, the trust region method, and the stochastic gradient descent method.

The parameter derivation unit 14 uses the Nelder-Mead method to set termination tolerances for both the CRF parameter and the function value to “10⁻⁴”, as an example.

In the case that a sigmoidal function expressed as the equation (3) is used as the camera response function, the parameter derivation unit 14 sets initial values of the respective CRF parameters “α=0” and “β=0”.

In the case that a “power function” expressed as the equation (6) is used as the camera response function, the parameter derivation unit 14 sets an initial value of the CRF parameter “γ” to “0”.

The transformed grayscale image derived by the parameter derivation unit 14 has the same global brightness as the global brightness of the enhanced grayscale image derived using the base image enhancement method.

In a case that the global brightness in the grayscale image can be adaptively enhanced by the base image enhancement method performed by the image enhancement unit 11, the parameter derivation unit 14 may adaptively set the CRF parameter in response to the situation of the grayscale image. In such a case, the luminance transform unit 15 can recover or enhance the local details attenuated in the image by the base image enhancement method using the luminance transform function of the exposure value matrix as a variable.

The luminance transform unit 15 acquires the grayscale image as an input image from the input unit 10. The luminance transform unit 15 acquires, as an input from the function derivation unit 12, the luminance transform function with the function value varying depending on the coordinates in the grayscale image on the basis of the camera response function. The luminance transform unit 15 acquires the exposure value matrix as an input from the matrix derivation unit 13. The luminance transform unit 15 acquires the CRF parameter as an input from the parameter derivation unit 14.

The luminance transform unit 15 applies the luminance transform function of the exposure value matrix and the CRF parameters as arguments to the luminances (pixel values) of the pixels of the grayscale image to derive a transformed grayscale image, which is a grayscale image with the global brightness being adaptively adjusted and a luminance being transformed such that the local details are enhanced. The luminance transform unit 15 outputs the transformed grayscale image to the output unit 16. The luminance transform unit 15 derives a transformed grayscale image “Aₒᵤₜ” as an equation 12).

[Math. 12]

Aₒᵤₜ=g(Aᵢₙ;θ) (12)

The output unit 16 is a display device, for example, a liquid crystal display. The output unit 16 acquires the transformed grayscale image “′Aₒᵤₜ” from the luminance transform unit 15. The output unit 16 displays the transformed grayscale image. The output unit 16 may be a communication device. The output unit 16 may transmit the transformed grayscale image to an external device (not illustrated).

Next, an operation example of the image adjustment apparatus 1 will be described.

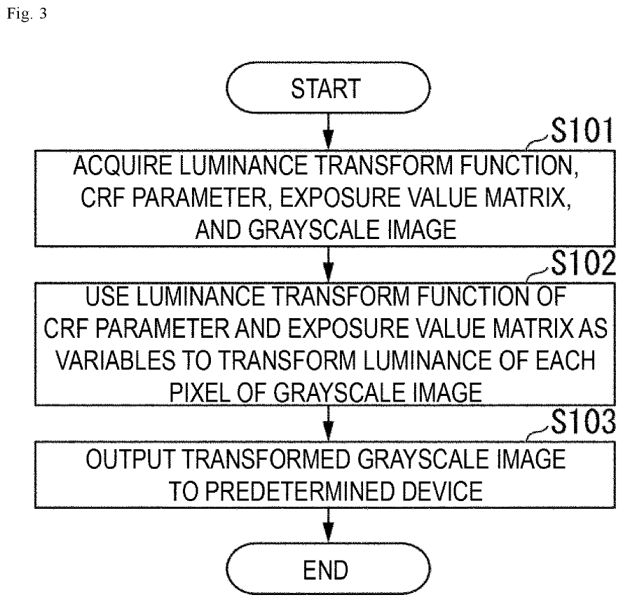

FIG. 3 is a flowchart illustrating an operation example of the luminance transform unit 15 of the image adjustment apparatus 1. The luminance transform unit 15 acquires a luminance transform function, a CRF parameter, an exposure value matrix, and a grayscale image (step S101). The luminance transform unit 15 uses the luminance transform function of the CRF parameter and the exposure value matrix as variables to transform the luminance of each pixel of the grayscale image (step S102). The luminance transform unit 15 outputs a transformed grayscale image to a predetermined device, such as the output unit 16 (step S103).

As described above, the image enhancement unit 11 generates an enhanced grayscale image, which is a grayscale image with the contrast of the luminance being enhanced, from the grayscale image. The function derivation unit 12 derives the luminance transform function on the basis of the camera response function. The matrix derivation unit 13 derives the exposure value matrix by use of the smooth grayscale image. The parameter derivation unit 14 derives the CRF parameter so that a difference between the enhanced grayscale image and the transformed grayscale image satisfies a predetermined condition by use of the luminance transform function, the enhanced grayscale image, the grayscale image, and the exposure value matrix. The luminance transform unit 15 acquires the luminance transform function, the CRF parameter, the exposure value matrix, and the grayscale image. The luminance transform unit 15 uses the luminance transform function of the CRF parameter and the exposure value matrix as variables to transform the luminance of each pixel of the grayscale image.

In this way, the image adjustment apparatus 1 uses the non-monotonic luminance transform function (the spatially varying function), that is, uses the function with a function value varying depending on the coordinates in the image, to transform the luminance of each pixel of the grayscale image. For example, the image adjustment apparatus 1 uses the luminance transform function of the CRF parameter and the exposure value matrix as variables to transform the luminance of each pixel of the grayscale image. This can enhance the local details in the image with the global brightness being adaptively adjusted. When the image enhancement method of the related art (the base image enhancement method) is used to enhance the input image, the local details attenuated (weakened) in the input image can be recovered or enhanced.

The transformed grayscale image derived by the luminance transform unit 15 has the same global brightness as the global brightness of the enhanced grayscale image derived using the base image enhancement method. In the case that the global brightness in the grayscale image can be adaptively enhanced by the base image enhancement method performed by the image enhancement unit 11, the parameter derivation unit 14 may adaptively set the CRF parameter in response to the situation of the grayscale image. In such a case, the luminance transform unit 15 can recover or enhance the local details attenuated in the image by the base image enhancement method using the luminance transform function of the exposure value matrix as a variable.

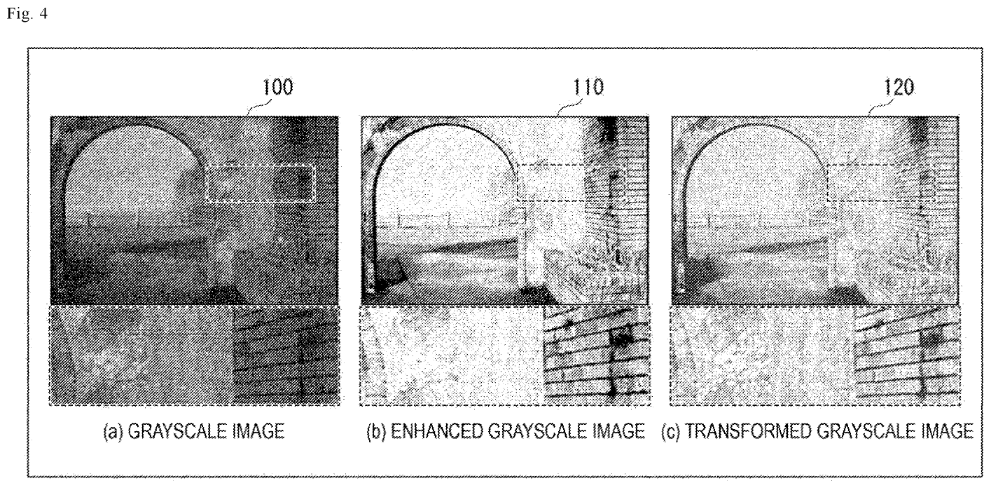

FIGS. 4 to 11 are diagrams illustrating first to eighth examples of a comparison between the transformed grayscale image and other images according to the embodiment. The sigmoidal function expressed the equation (3) is used as the camera response function in generating the transformed grayscale image in FIGS. 4 to 11.

In FIGS. 4 to 7, enhanced grayscale images derived using the base image enhancement method (the method described in NPL 1) and transformed grayscale images derived by the luminance transform unit 15 are illustrated in a comparable manner.

FIG. 4 illustrates, in a comparable manner, a grayscale image 100, an enhanced grayscale image 110, and a transformed grayscale image 120, the enhanced grayscale image 110 resulting from applying the base image enhancement method to the grayscale image 100, the transformed grayscale image 120 resulting from applying the luminance transform function of the exposure value matrix and the CRF parameter as variables to the grayscale image 100.

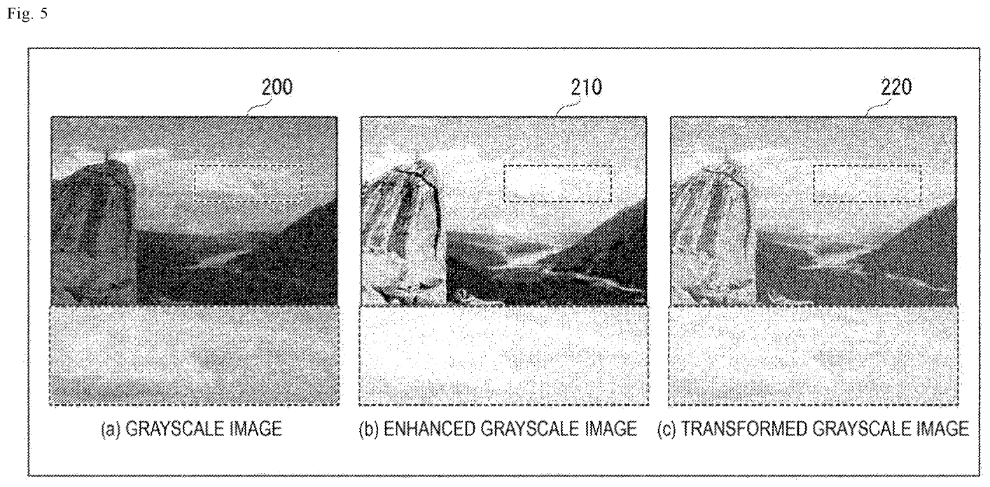

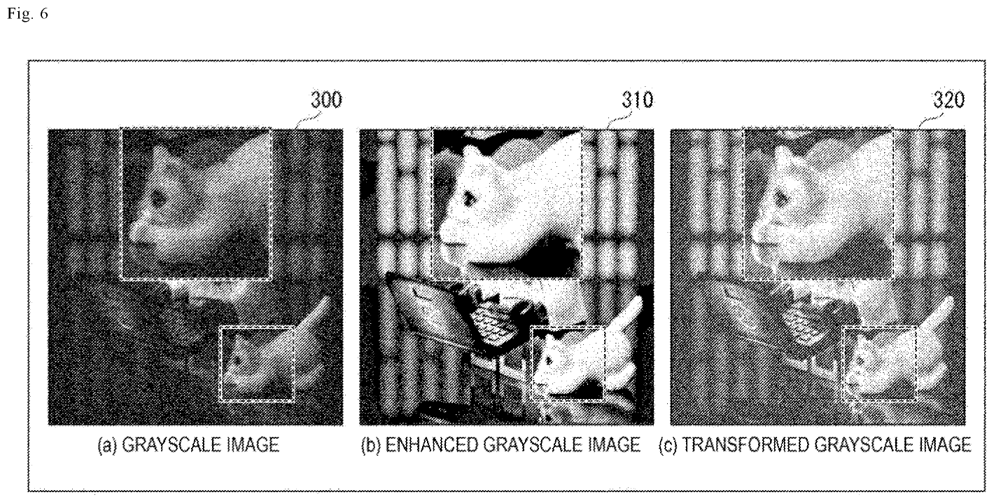

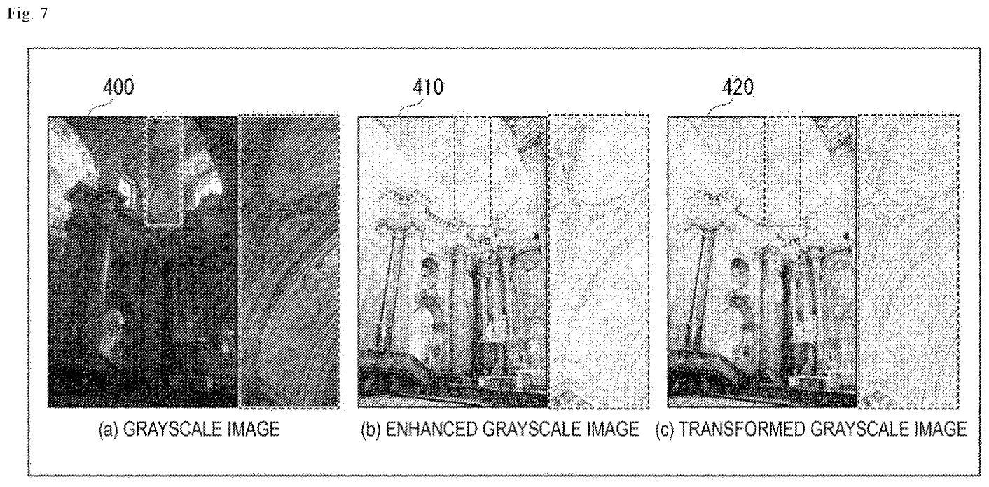

Similarly, FIG. 5 illustrates a grayscale image 200, an enhanced grayscale image 210, and a transformed grayscale image 220 in a comparable manner. FIG. 6 illustrates a grayscale image 300, an enhanced grayscale image 310, and a transformed grayscale image 320 in a comparable manner. FIG. 7 illustrates a grayscale image 400, an enhanced grayscale image 410, and a transformed grayscale image 420 in a comparable manner.

As represented by the enhanced grayscale image 110, the enhanced grayscale image 210, the enhanced grayscale image 310, and the enhanced grayscale image 410, some local details in the image are necessarily attenuated in the enhanced grayscale image generated from the grayscale images by the base image enhancement method. Because the base image enhancement method is designed to enhance the contrast of a dark image region, local details of a bright region in the image tend to attenuate.

As represented by the transformed grayscale image 120, the transformed grayscale image 220, the transformed grayscale image 320, and the transformed grayscale image 420, it is possible to, in the transformed grayscale image derived by the luminance transform unit 15, recover or enhance the local details of the image attenuated by the base image enhancement method while maintaining the global brightness in the enhanced grayscale images.

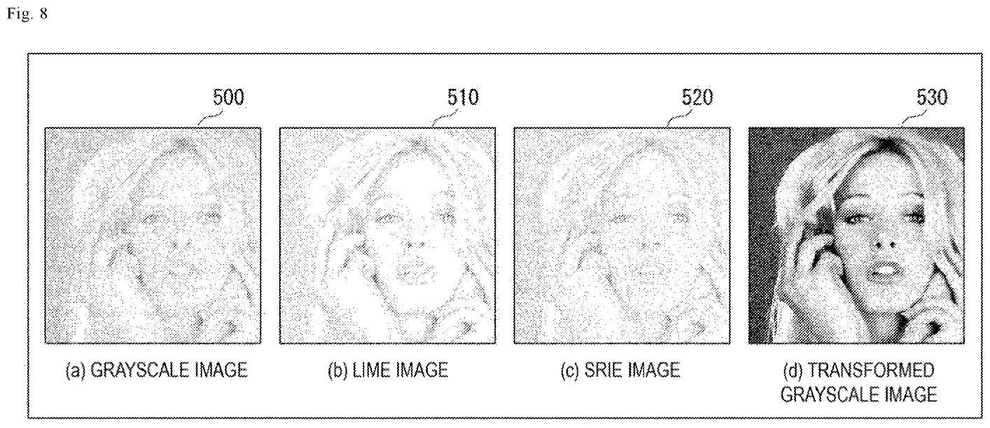

FIGS. 8 to 11 illustrate, in a comparable manner, grayscale images, “low-light image enhancement (LIME) images” derived using the method described in NPL 2, “simultaneous reflectance and illumination estimation (SRIE) images” derived using the method described in NPL 3, and transformed grayscale images derived by the luminance transform unit 15.

FIG. 8 illustrates, in a comparable manner, a grayscale image 500, a LIME image 510, a SRIE image 520, and a transformed grayscale image 530, the LIME image 510 resulting from applying the method described in NPL 2 to the grayscale image 500, the SRIE image 520 resulting from applying the method described in NPL 3 to the grayscale image 500, the transformed grayscale image 530 resulting from applying the luminance transform function of the exposure value matrix and the CRF parameter as variables to the grayscale image 500.

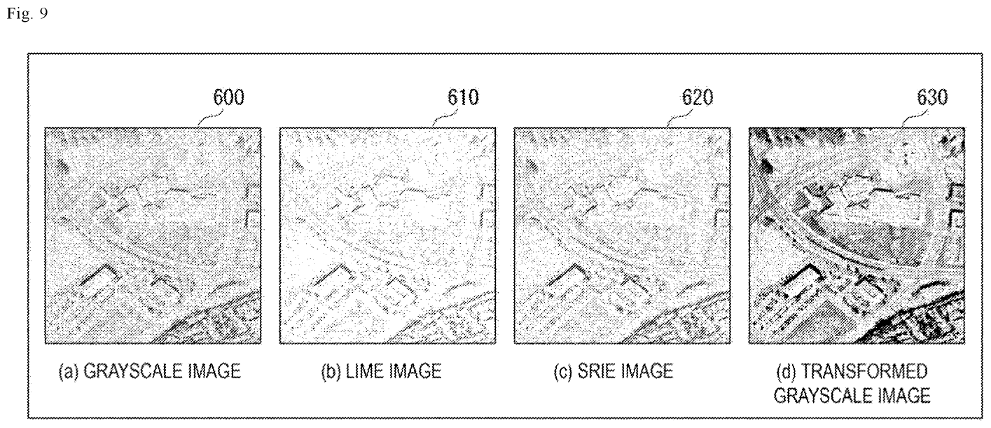

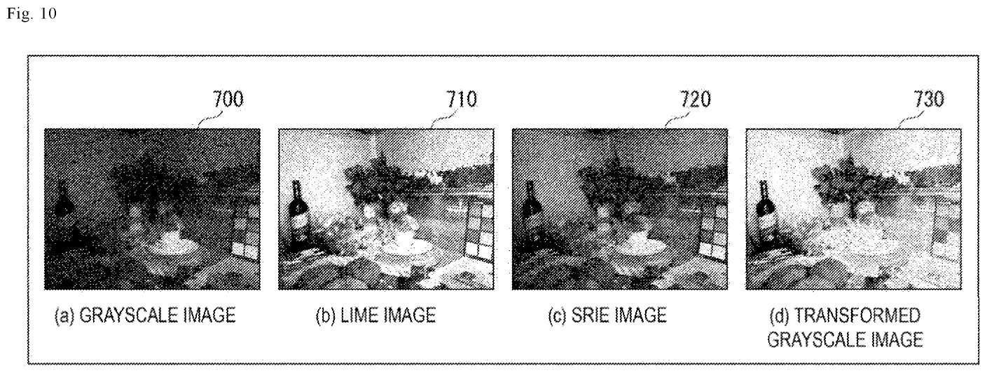

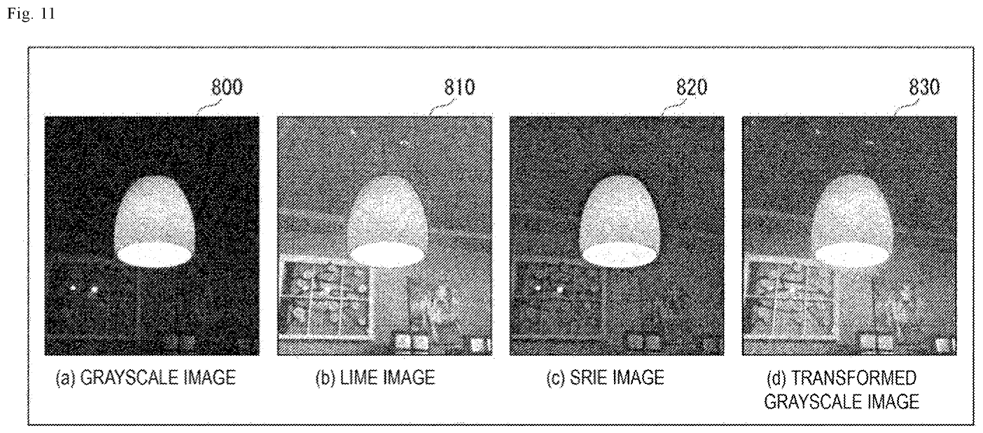

Similarly, FIG. 9 illustrates a grayscale image 600, a LIME image 610, a SRIE image 620, and a transformed grayscale image 630 in a comparable manner. FIG. 10 illustrates a grayscale image 700, a LIME image 710, a SRIE image 720, and a transformed grayscale image 730 in a comparable manner. FIG. 11 illustrates a grayscale image 800, a LIME image 810, a SRIE image 820, and a transformed grayscale image 830 in a comparable manner.

In the method described in NPL 2, the reflectance component image is considered as a desired enhancement result. An estimated illumination component image is removed from the grayscale image to derive an enhancement result. However, as represented by the LIME image 510, the LIME image 610, and the LIME image 810, the global contrast in the LIME image may be completely eliminated. As a result, problems such as excessive brightness may be sometimes generated.

In the method described in NPL 3, the estimated illumination component image is enhanced with the gamma correction. The enhanced illumination component image and the reflectance component image are recombined. The recombined image is derived as an enhancement result. However, as represented by the SRIE image 520, the SRIE image 620, the SRIE image 720, and the SRIE image 820, the gamma correction may not be used to adaptively enhance the brightness in the image. As a result, problems may arise in which the brightness of the SRIE image may be excessive. In addition, problems may arise in which the brightness of the SRIE image may be insufficient.

In the method in which the luminance transform function of the exposure value matrix and the CRF parameter as variables is applied to the grayscale image (the method in which the luminance transform function is used that is not monotonically but spatially varies within the image and has a different value depending on the coordinates of each pixel), balanced natural contrast enhancement is consistently possible, as represented by the transformed grayscale image 530, the transformed grayscale image 630, the transformed grayscale image 730, and the transformed grayscale image 830. In such a method, the global brightness in the image is adaptively enhanced in response to the situation of the grayscale image without the local details of the image being weakened. Additionally, the problems in which the brightness of the image may be excessive and the problems in which the brightness of the image may be insufficient can be efficiently prevented from arising.

Although the embodiments of the present invention have been described in detail with reference to the drawings, a specific configuration is not limited to the embodiments, and a design or the like in a range that does not depart from the gist of the present invention is included.

For example, the “luminance” may be interpreted as the “brightness.”

### INDUSTRIAL APPLICABILITY

The present invention is applicable to the image processing apparatus.

### REFERENCE SIGNS LIST

1 . . . Image adjustment apparatus
2 . . . Processor
3 . . . Memory
4 . . . Storage device
5 . . . Display unit
10 . . . Input unit
11 . . . Image enhancement unit
12 . . . Function derivation unit
13 . . . Matrix derivation unit
14 . . . Parameter derivation unit
15 . . . Luminance transform unit
16 . . . Output unit
100 . . . Grayscale image
110 . . . Enhanced grayscale image
120 . . . Transformed grayscale image
200 . . . Grayscale image
210 . . . Enhanced grayscale image
220 . . . Transformed grayscale image
300 . . . Grayscale image
310 . . . Enhanced grayscale image
320 . . . Transformed grayscale image
400 . . . Grayscale image
410 . . . Enhanced grayscale image
420 . . . Transformed grayscale image
500 . . . Grayscale image
510 . . . LIME image
520 . . . SRIE image
530 . . . Transformed grayscale image
600 . . . Grayscale image
610 . . . LIME image
620 . . . SRIE image
630 . . . Transformed grayscale image
700 . . . Grayscale image
710 . . . LIME image
720 . . . SRIE image
730 . . . Transformed grayscale image
800 . . . Grayscale image
810 . . . LIME image
820 . . . SRIE image
830 . . . Transformed grayscale image

1. An image adjustment apparatus comprising:
a processor; and
a storage medium having computer program instructions stored thereon, when executed by the processor, perform to:
acquire a grayscale image, the grayscale image being an image representing a contrasting density using a contrast of luminance; and
transform luminances of pixels of the grayscale image using a luminance transform function with a function value varying depending on coordinates in the grayscale image on the basis of a camera response function to generate a transformed grayscale image and output the transformed grayscale image to a predetermined device, the transformed grayscale image being the grayscale image with a global brightness being adaptively adjusted and with the luminance being transformed in such a manner that local details are enhanced.

2. The image adjustment apparatus according to claim 1, wherein the computer program instructions further perform to
generate, from the grayscale image, an enhanced grayscale image being the grayscale image with the luminance being adjusted;
derive the luminance transform function on the basis of the camera response function;
derive an exposure value matrix being a positive real matrix inversely proportional to pixel values of a smooth grayscale image, the smooth grayscale image being obtained by smoothing the grayscale image; and
derive parameters so that a difference between the enhanced grayscale image and the transformed grayscale image satisfies a predetermined condition, by use of the luminance transform function, the enhanced grayscale image, the grayscale image, and the exposure value matrix, wherein the luminance transform unit uses the luminance transform function of the exposure value matrix and the parameters as variables to transform the luminances of the pixels of the grayscale image.

3. The image adjustment apparatus according to claim 2, wherein the predetermined condition is a condition that a residual sum of squares between the enhanced grayscale image and the transformed grayscale image is minimized.

4. An image adjustment method performed by an image adjustment apparatus, the image adjustment method comprising:
acquiring a grayscale image, the grayscale image being an image representing a contrasting density using a contrast of luminance; and
transform luminances of pixels of the grayscale image using a luminance transform function with a function value varying depending on coordinates in the grayscale image on the basis of a camera response function to generate a transformed grayscale image and output the transformed grayscale image to a predetermined device, the transformed grayscale image being the grayscale image with a global brightness being adaptively adjusted and with the luminance being transformed in such a manner that local details are enhanced.

5. A non-transitory computer-readable medium having computer-executable instructions that, upon execution of the instructions by a processor of a computer, cause the computer to function as the image adjustment apparatus according to claim 1.
